(19) United States
(12) Patent Application Publication
(10) Pub. No.: US 2008/0062528 A1
(43) Pub. Date: Mar. 13, 2008

(54) OPTICAL HEAD DEVICE

(75) Inventors: Masaki Sasaki, Nagano (JP); Kai Suo, Nagano (JP)

Correspondence Address: CANTOR COLBURN, LLP, 20 Church Street, 22nd Floor, Hartford, CT, 06103, US

(73) Assignee: NIDEC SANKYO CORPORATION, Nagano (JP)

(21) Appl. No.: 11/851,001

(22) Filed: Sep. 6, 2007

(30) Foreign Application Priority Data
Sep. 7, 2006 (JP) 2006-243383

(51) Int. Cl. G02B 27/14

(52) U.S. Cl. 359/637

(57) ABSTRACT

An optical head device may include a laser light source, an objective lens for converging a laser beam emitted from the laser light source on an optical recording medium, a parallel planar half mirror which is disposed on an optical path directing from the laser light source to the optical recording medium and which partially transmits the laser beam emitted from the laser light source diagonally as a divergent beam, and an aberration correcting element for correcting aberration which is occurred when the laser beam before converged on the optical recording medium is transmitted through the half mirror. Since the aberration correcting element is disposed on an optical path directing from the laser light source to the optical recording medium, a satisfactory spot can be formed on an optical recording medium.

### CROSS REFERENCE TO RELATED APPLICATION

The present invention claims priority under 35 U.S.C. § 119 to Japanese Application No. 2006-243383 filed Sep. 7, 2006, which is incorporated herein by reference.

### FIELD OF THE INVENTION

An embodiment of the present invention may relate to an optical head device for reproducing and/or recording information from and/or into an optical recording medium such as a CD or a DVD.

### BACKGROUND OF THE INVENTION

In an optical head device which is used for reproducing and/or recording information from and/or into an optical recording medium such as a CD or a DVD, various structures have been proposed to correct aberration occurred in an emitted light beam on an optical path from a light source to an optical recording medium. For example, the following structures have been proposed, a structure in which aberration due to dimensional errors and the like in an optical system is corrected by a liquid crystal element (see, for example, Japanese Patent Laid-Open No. 2000-40249), a structure in which astigmatism due to a light source is corrected by a cylindrical lens (see, for example, Japanese Patent Laid-Open No. Hei 10-83555), and a structure in which coma aberration and astigmatism occurred in a laser beam diagonally transmitting through a half mirror in an optical path from a disk to a light receiving element are corrected by a correcting lens (see, for example, Japanese Patent Laid-Open No. 2000-348365).

In an optical head device, an optical path separation element is disposed for separating a laser beam which is directed to an optical recording medium from a laser light source from a return light beam from the optical recording medium. In this case, since a prism is expensive, a half mirror formed in a parallel planar shape which is inexpensive is sometimes used as the optical path separation element instead of using the prism. However, when the laser beam is diagonally transmitted through the parallel planar half mirror, astigmatism and coma aberration are occurred to cause a problem in detection of a focusing error signal and the like, but the problem can be eliminated by the technique described in the above-mentioned patent references.

Further, an optical path separation element for separating a laser beam directing to an optical recording medium from a laser light source from a return light beam from the optical recording medium may be used on an optical path directing to the optical recording medium from the laser light source. Alternatively, a semi-transmission film (half mirror) prism may be used as an optical path composite element for composing optical paths of laser beams emitted from two laser light sources. In this case, when a parallel planar half mirror is used, a laser beam is diagonally transmitted through the parallel planar half mirror as a divergent beam and thus astigmatism and coma aberration are occurred and a satisfactory spot is difficult to be formed on an optical recording medium. Therefore, conventionally, on the optical path directing to an optical recording medium from a laser light source, a prism is used at the sacrifice of cost and, alternatively, a parallel planar half mirror is used instead of the prism at the sacrifice of a satisfactory spot shape on the optical recording medium.

### SUMMARY OF THE INVENTION

In view of the problems described above, an embodiment of the present invention may advantageously provide an optical head device which is capable of forming a satisfactory spot on an optical recording medium even when a parallel planar half mirror is disposed on an optical path directing from a laser light source to the optical recording medium instead of a prism to reduce its cost.

Further, an embodiment of the present invention may advantageously provide an optical head device which is capable of forming a satisfactory spot on an optical recording medium at a low cost by reducing aberration which is occurred when a laser beam is transmitted through the parallel planar half mirror as a divergent beam.

Further, an embodiment of the present invention may advantageously provide an optical head device which is capable of forming satisfactory spots for two laser beams on an optical recording medium even when a parallel planar half mirror is used as an optical path composite element for composing optical paths of the two laser beams emitted from two laser light sources.

Thus, according to an embodiment of the present invention, there may be provided an optical head device including a laser light source, an objective lens for converging a laser beam emitted from the laser light source on an optical recording medium, a parallel planar half mirror which is disposed on an optical path directing from the laser light source to the optical recording medium and which partially transmits the laser beam emitted from the laser light source diagonally as a divergent beam, and an aberration correcting element for correcting aberration which is occurred when the laser beam before converged on the optical recording medium is transmitted through the half mirror.

In accordance with an embodiment of the present invention, a parallel planar half mirror is used, on an optical path directing from a laser light source to an optical recording medium, as an optical path separation element for separating a laser beam, which directs from the laser light source to the optical recording medium, from a return light beam from the optical recording medium, or as an optical path composite element for composing optical paths of laser beams emitted from two laser light sources. Therefore, cost can be reduced in comparison with a case when a prism is used. Further, an aberration correcting element for correcting aberration which is occurred when the laser beam before converged on the optical recording medium is transmitted through the half mirror is disposed on an optical path directing from the laser light source to the optical recording medium. Therefore, a satisfactory spot can be formed on an optical recording medium.

In accordance with an embodiment, an incident angle of the laser beam to the half mirror is set to be less than 45°. According to the structure as described above, since the incident angle of the laser beam to the half mirror becomes closer to a vertical incidence to the half mirror, a length of the optical path of the laser beam transmitting through the half mirror is shortened and thus aberration becomes smaller which is occurred when the laser beam is transmitted through the half mirror. Therefore, since a correcting amount of the aberration required to the aberration correcting element is reduced, designing of the aberration correcting element can be performed easily.

In accordance with an embodiment, the aberration correcting element is disposed on an optical path directing from the laser light source to the half mirror. According to the structure as described above, in a case that the parallel planar half mirror is used as an optical path separation element for separating a laser beam which directs from the laser light source to the optical recording medium from a return light beam from the optical recording medium, the return light beam from the optical recording medium does not pass through the aberration correcting element. Therefore, optical designing for the aberration correcting element is required to correct only aberration occurred when the laser beam directing to the optical recording medium is transmitted through the half mirror. Further, when two laser light sources (laser beam emitting elements) are used as described below, only the laser beam transmitting through the parallel planar half mirror passes through the aberration correcting element and the aberration correcting element does not affect the other laser beam which is reflected by the parallel planar half mirror. Therefore, optical designing of the aberration correcting element can be easily performed.

In other words, in accordance with an embodiment, a first laser beam emitting element which emits a first laser beam and a second laser beam emitting element which emits a second laser beam are provided. The first laser beam emitting element is a light source whose emitted light beam transmits the half mirror diagonally as a divergent beam. The half mirror partially transmits the first laser beam and partially or totally reflects the second laser beam to compose optical paths for the first laser beam and the second laser beam directing to the optical recording medium. Further, the aberration correcting element is disposed on an optical path directing from the first laser beam emitting element to the half mirror. In this case, the first laser beam may be a laser beam with a wavelength of 780 nm band and the second laser beam may be a laser beam with a wavelength of 650 nm band.

In accordance with an embodiment, the aberration correcting element is a toric lens. When a toric lens is used, coma aberration when the first laser beam is transmitted through the half mirror is corrected by inclination of a lens face with respect to a center optical axis of the first laser beam, and astigmatism when the first laser beam is transmitted through the half mirror is corrected by anisotropy of a radius of curvature of a lens face.

The toric lens is preferably provided with a lens face which occurs aberration in an opposite direction to aberration which is occurred when the laser beam is transmitted through the half mirror, and the laser beam is converged on the optical recording medium in a state that the aberration which is occurred when the laser beam is transmitted through the half mirror is corrected. Specifically, the toric lens may be provided with a toric face on one of its lens faces and a convex face on the other of the lens faces, coma aberration is occurred by inclination of the toric face and the convex face on an opposite direction to coma aberration which is occurred when the laser beam is transmitted through the half mirror. Further, coma aberration is occurred by anisotropy of a radius of curvature of the toric face on an opposite direction to astigmatism which is occurred when the laser beam is transmitted through the half mirror, and the laser beam is converged on the optical recording medium in the state that the aberration which is occurred when the laser beam is transmitted through the half mirror is corrected.

In accordance with an embodiment, the toric lens is provided with a function of a magnification conversion lens which sets an optical magnification from the first laser beam emitting element to the optical recording medium in a predetermined value.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1(A) is a plan view showing an optical head device in accordance with an embodiment of the present invention, FIG. 1(B) is its side view, and FIG. 1(C) is its bottom view in which a bottom cover and the like are detached.

FIG. 2 is a schematic structural view showing an optical system of an optical head device in accordance with an embodiment of the present invention.

### DETAILED DESCRIPTION OF THE PREFERRED EMBODIMENTS

An optical head device in accordance with an embodiment of the present invention will be described below with reference to the accompanying drawings.

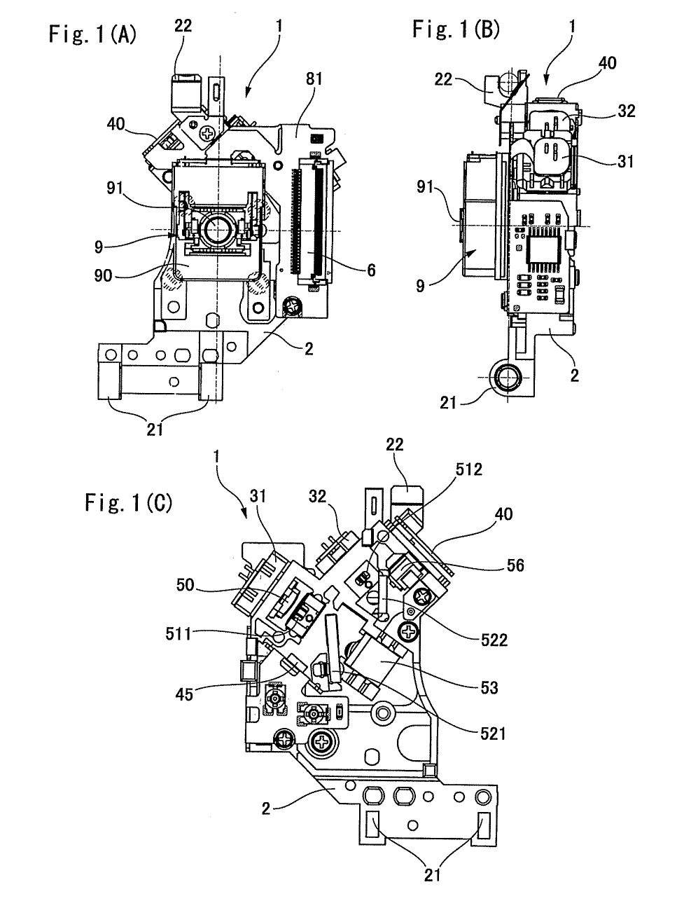

FIG. 1(A) is a plan view showing an optical head device in accordance with an embodiment of the present invention, FIG. 1(B) is its side view, and FIG. 1(C) is its bottom view in which a bottom cover and the like are detached.

In FIGS. 1(A), 1(B) and 1(C), an optical head device 1 in accordance with an embodiment performs reproducing and/or recording information from and/or into an optical recording medium (optical recording disk) such as a CD or a DVD. The optical head device 1 includes a device frame 2 which is formed of a die casting product made of metal such as magnesium or zinc or made of resin. Both ends of the device frame 2 are formed with a first bearing part 21 and a second bearing part 22 which are engaged with a guide shaft and a feed screw shaft (not shown) of a disk drive device. A side face of one side of the device frame 2 is recessed in a roughly circular arc shape to prevent interference with a spindle motor (not shown) of the disk drive mechanism when the device frame 2 is moved near the spindle motor.

An objective lens 91 is disposed at a roughly center position on an upper face side of the device frame 2 and an objective lens drive mechanism 9 for servo-controlling a position of the objective lens 91 in a focusing direction and a tracking direction is mounted on the device frame 2. In the optical head device 1 in this embodiment, recording and reproduction are performed by using a first laser beam and a second laser beam through a common objective lens 91. Therefore, a two-wavelength lens on which a diffraction grating is formed with concentrically circular shape grooves or step portions is used as the objective lens 91. In this embodiment, a wire suspension type of objective lens drive mechanism 9 is used, which is well-known and thus a detail description is omitted. The objective lens drive mechanism 9 is provided with a lens holder which holds the objective lens 91, a holder support part which movably supports the lens holder in a tracking direction and a focusing direction with a plurality of wires, and a yoke which is fixed to the device frame 2. Further, the objective lens drive mechanism 9 is provided with a magnetic-drive circuit which is structured of drive coils attached to the lens holder and drive magnets attached to the yoke. The objective lens 91 supported by the lens holder is driven in a tracking direction and a focusing direction with respect to an optical recording medium by controlling energization to the drive coils. Further, the objective lens drive mechanism 9 is capable of performing a tilt control for adjusting an inclination of the objective lens 91 in a jitter direction. The periphery of the objective lens 91 is covered with an actuator cover 90 in a rectangular frame shape.

A flexible circuit board 81 on which a connector 6 and the like are mounted is disposed on the device frame 2. Power and signal are supplied to laser light sources 31 and 32 described below and a light receiving element 40 for signal detection through the flexible circuit board 81.

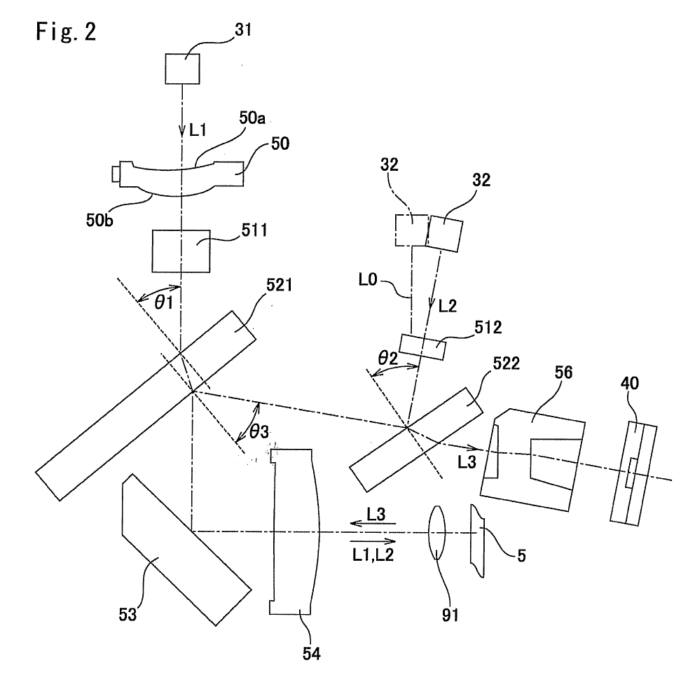

FIG. 2 is a schematic structural view showing an optical system of an optical head device in accordance with an embodiment of the present invention.

As shown in FIG. 1(C) and FIG. 2, the optical head device 1 in this embodiment is a two-wavelength optical head device which is capable of recording and reproducing information into and from a CD system disk or a DVD system disk, or other optical medium, by using a first laser beam with a wavelength of 780 nm band and a second laser beam with a wavelength of 650 nm band. A first laser light source 31 provided with a laser diode of AlGaInP system (first laser beam emitting element) which emits a first laser beam and a second laser beam source 32 provided with a laser diode of AlGaAs system (second laser beam emitting element) which emits a second laser beam are mounted on adjacent positions in an end part of the device frame 2. Therefore, as shown in FIG. 2, the optical head device 1 is structured of a first optical path L1 as a first forward path which directs from the first laser light source 31 toward a recording face of the optical recording medium 5, a second optical path L2 as a second forward path which directs from the second laser beam source 32 to the recording face of the optical recording medium 5, and a third optical path L3 as a return path which directs from the recording face of the optical recording medium 5 to the light receiving element 40 for signal detection.

In order to structure the optical paths L1, L2 and L3, the optical head device 1 in this embodiment includes; along the first optical path L1, a first diffraction element 511 for diffracting the first laser beam emitted from the first laser light source 31 into three beams for tracking detection, a parallel planar half mirror 521 which partially transmits the three laser beams divided by the first diffraction element 511, and a directing mirror 53 which directs the laser beams emitted from the half mirror 521 to the optical recording medium 5. A collimating lens 54 for forming the laser beam in a parallel light and the objective lens 91 for converging the parallel light beam from the collimating lens 54 on the recording face of the optical recording medium 5 are disposed on an upper position of the directing mirror 53.

Further, in the optical head device 1 in this embodiment, a second diffraction element 512, which diffracts the second laser beam emitted from the second laser light source 32 into three beams for tracking detection, and an optical path separation element 522 comprising of a parallel planar half mirror, which partially reflects the three laser beams divided by the second diffraction element 512 are disposed along the second optical path L2.

In this embodiment, the parallel planar half mirror 521 is used as an optical path composite element which composes the first optical path L1 and the second optical path L2. The laser beam which is reflected by the optical path separation element 522 is partially reflected by the half mirror 521 and, after that, similarly to the first laser beam, the laser beam is irradiated on the recording face of the optical recording medium 5 through the directing mirror 53, the collimating lens 54 and the objective lens 91.

Further, in the third; optical path L3 in the optical head device 1 in this embodiment, the return light beam which is reflected by the recording face of the optical recording medium 5 is partially reflected by the half mirror 521 through the collimating lens 54 and the directing mirror 53 and, after that, the return light beam partially transmits the optical path separation element 522 and then an astigmatism is applied to the return light beam by a sensor lens 56 to reach to the light receiving element 40 for signal detection.

As shown in FIG. 1(C), a light receiving element 45 for monitor, which receives the first laser beam partially reflected by the half mirror 521 and the second laser beam partially transmitted through the half mirror 521 is disposed near the half mirror 521.

In the optical head device 1 in this embodiment, an aberration correcting element 50 for correcting aberration (coma aberration and astigmatism) which occurs when an emitted light beam of the first laser light source 31 is transmitted through the half mirror 521 as a divergent beam is disposed between the first laser light source 31 and the half mirror 521, specifically between the first laser light source 31 and the first diffraction element 511 on the first optical path L1.

In this embodiment, a toric lens is used as the aberration correcting element 50. The toric lens is provided with a toric face 50a on its one face side (first laser light source 31 side) and a convex face 50b on the other face side. The aberration correcting element 50 (toric lens) is disposed so as to be inclined with respect to an optical axis of the emitted light beam of the first laser light source 31 with a predetermined angle. Therefore, the toric face 50a and the convex face 50b incline with respect to the optical axis of the emitted light beam of the first laser light source 31 with the predetermined angle. Accordingly, since the toric face 50a and the convex face 50b of the aberration correcting element 50 are inclined with respect to the center optical axis of the first laser beam, coma aberration is generated in an opposite direction to the coma aberration which is occurred when the first laser beam is transmitted through the half mirror 521. As a result, the coma aberration occurred when the first laser beam is transmitted through the half mirror 521 is corrected. Further, the aberration correcting element 50 generates coma aberration in an opposite direction to the astigmatism which is occurred when the first laser beam is transmitted through the half mirror 521 by an anisotropy of radius of curvature of the toric face 50a and thus the astigmatism occurred when the first laser beam is transmitted through the half mirror 521 is corrected.

In accordance with an embodiment of the present invention, while an optical magnification in the second optical path L2 directing from the second laser light source 32 to the optical recording medium is preferably set in, for example, in a range from about 6.5 times to about 7.5 times, an optical magnification in the first optical path L1 directing from the first laser light source 31 to the optical recording medium is preferably set in, for example, in a range from about 3.5 times to about 5.0 times. However, in the first optical path L1 and the second optical path L2, the collimating lens 54 and the objective lens 91 are commonly used and, in addition, there is a restriction in a layout. Therefore, in this embodiment, the toric lens which is used as the aberration correcting element 50 is also used as a magnification conversion lens to the first laser beam, and the optical magnification in the first optical path L1 directing from the first laser light source 31 to the optical recording medium is optimized by the aberration correcting element 50 (toric lens).

Further, in this embodiment, an incident angle θ1 of the first laser beam to the half mirror 521 is set to be less than 45° (specifically 40° in this embodiment). Therefore, a length of an optical path of first laser beam transmitting through the half mirror 521 can be shortened and, since the incident angle θ1 of the first laser beam to the half mirror 521 becomes closer to a vertical incidence to the half mirror 521, aberration becomes smaller which is occurred when the first laser beam is transmitted through the half mirror 521. In accordance with an embodiment of the present invention, an incident angle θ2 of the second laser beam to the optical path separation element 522 is set to be 45°. However, an incident angle θ3 of the second laser beam to the half mirror 521 is set to be the same angle (40° in this embodiment) as the incident angle θ1 of the first laser beam to the half mirror 521.

As described above, in the optical head device 1 in this embodiment, the parallel planar half mirror 521 is used as the optical path composite element which partially transmits the first laser beam emitted from the first laser light source 31 and partially reflects the second laser beam emitted from the second laser light source 32. Therefore, cost can be reduced in comparison with a case where a prism is used as the optical path composite element.

Further, the aberration correcting element 50 for correcting the aberration which is occurred when the first laser beam is diagonally transmitted through the half mirror 521 as a divergent beam is disposed on the first optical path L1 directing from the first laser light source 31 to the optical recording medium. Therefore, a satisfactory spot can be formed on the optical recording medium 5.

In addition, the aberration correcting element 50 is disposed on the optical path which directs to the half mirror 521 from the first laser light source 31. Therefore, even when two laser light sources 31 and 32 are used, only the first laser beam transmitting through the half mirror 521 passes through the aberration correcting element 50 and the aberration correcting element 50 does not affect the second laser beam which is reflected by the parallel planar half mirror 521. Accordingly, optical designing of the aberration correcting element 50 can be easily performed.

Further, when the incident angle θ1 of the first laser beam to the half mirror 521 is set to be less than 45°, a length of the optical path of the first laser beam transmitting through the half mirror 521 is shortened and, since the incident angle θ1 of the first laser beam to the half mirror 521 becomes closer to a vertical incidence to the half mirror, aberration becomes smaller which is occurred when the first laser beam is transmitted through the half mirror 521. Therefore, since a correcting amount of the aberation required to the aberration correcting element 50 is reduced, a toric lens can be used as the aberration correcting element 50 and designing of the toric lens becomes easy.

Further, in this embodiment, the toric lens which is used as the aberration correcting element 50 is also functioned as a magnification conversion lens to the first laser beam. Therefore, a magnification conversion lens is not required to prepare separately and thus cost can be further reduced.

In addition, when the incident angle θ1 of the first laser beam to the half mirror 521 is set to be less than 45°, the laser light sources 31 and 32 can be disposed to be apart from each other even when the size of the device frame 2 is reduced. Therefore, mounting work of the laser light sources 31 and 32 and positional adjustment work of the laser light sources 31 and 32 can be performed easily. I For example, when the incident angle θ2 of the second laser beam to the half mirror 522 is set to be less than 45°, as shown by the alternate long and short dash line “L0” in FIG. 2, the emitted optical axes of the laser light sources 31 and 32 become parallel to each other and thus the laser light sources 31 and 32 are closely disposed. On the contrary, when the incident angle θ1 of the first laser beam to the half mirror 521 is set to be less than 45°, the emitted optical axis of the second laser light source 32 is inclined in a direction such that the laser light sources 31 and 32 are located apart from each other.

In the embodiment described above, a toric lens having the toric face 50a on its one face side is used as the aberration correcting element 50. However, a cylindrical lens may be used instead of using the toric lens.

Further, the embodiment described above is structured so that both the coma aberration and the astigmatism are corrected by one piece of the aberration correcting element 50. However, the coma aberration and the astigmatism may be structured to be corrected by separate aberration correcting elements.

In addition, in the embodiment described above, the aberration correcting element 50 is structured so that both the aberration correcting function and the optical magnification modifying function are provided. However, separate elements may be used for the aberration correcting function and for the optical magnification modifying function. Further, the first diffraction element 511 may be structured so as to have an aberration correcting function and used as a toric lens by providing a toric face on one face of the first diffraction element 511 (face of the first laser light source 31 side).

In addition, in the embodiment described above, the parallel planar half mirror 521 is used as the optical path composite element which partially transmits the first laser beam emitted from the first laser light source 31 and partially reflects the second laser beam emitted from the second laser light source 32. However, the present invention may be applied to a case that a laser beam directing from a laser light source to an optical recording medium is transmitted through a parallel planar half mirror which is used to separate the laser beam directing from the laser light source to the optical recording medium from a return light beam from the optical recording medium.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical head device for use with an optical recording medium comprising:
a laser light source;
an objective lens for converging a laser beam emitted from the laser light source on the optical recording medium;
a parallel planar half mirror which is disposed on an optical path directing from the laser light source to the optical recording medium and which partially transmits the laser beam emitted from the laser light source diagonally as a divergent beam; and
an aberration correcting element for correcting aberration which is occurred when the laser beam before converged on the optical recording medium is transmitted through the half mirror.

2. The optical head device according to claim 1, wherein an incident angle of the laser beam to the half mirror is set to be less than 45°.

3. The optical head device according to claim 2, wherein the aberration correcting element is disposed on an optical path directing from the laser light source to the half mirror.

4. The optical head device according to claim 3,
wherein the laser light source is a first laser beam emitting element which emits a first laser beam,
further comprising a second laser beam emitting element which emits a second laser beam,
wherein the half mirror partially transmits the first laser beam and partially or totally reflects the second laser beam to compose an optical path of the first laser beam and the second laser beam directing to the optical recording medium.

5. The optical head device according to claim 4, wherein the aberration correcting element is a toric lens.

6. The optical head device according to claim 5, wherein the toric lens is also provided with a function of a magnification conversion lens which sets an optical magnification from the first laser beam emitting element to the optical recording medium in a predetermined value.

7. The optical head device according to claim 4, wherein the first laser beam is a laser beam with a wavelength of 780 nm band and the second laser beam is a laser beam with a wavelength of 650 nm band.

8. The optical head device according to claim 1, wherein the aberration correcting element is one of a toric lens and a cylindrical lens.

9. The optical head device according to claim 8, wherein
the toric lens is provided with a lens face which generates aberration in an opposite direction to aberration which is occurred when the laser beam is transmitted through the half mirror, and
the laser beam is converged on the optical recording medium in a state that the aberration which is occurred when the laser beam is transmitted through the half mirror is corrected.

10. The optical head device according to claim 9, wherein
the toric lens is provided with a toric face on one of its lens faces and a convex face on the other of the lens faces,
coma aberration is generated by inclination of the toric face and the convex face on an opposite direction to coma aberration which is occurred when the laser beam is transmitted through the half mirror,
coma aberration is generated by anisotropy of a radius of curvature of the toric face on an opposite direction to astigmatism which is occurred when the laser beam is transmitted through the half mirror, and
the laser beam is converged on the optical recording medium in the state that the aberration which is occurred when the laser beam is transmitted through the half mirror is corrected.
